(19) United States
(12) Patent Application Publication
(10) Pub. No.: US 2019/0266142 A1
(43) Pub. Date: Aug. 29, 2019

(54) DATA INTEGRATION METHOD, DATA INTEGRATION DEVICE, DATA PROCESSING SYSTEM, AND COMPUTER PROGRAM

(71) Applicant: TURBO DATA LABORATORIES, INC., Kanagawa (JP)

(72) Inventor: Shinji Furusho, Kanagawa (JP)

(21) Appl. No.: 16/333,475

(22) PCT Filed: Aug. 10, 2017
(86) PCT No.: PCT/JP2017/029139

§ 371 Date: Mar. 14, 2019

(30) Foreign Application Priority Data
Sep. 14, 2016 (JP) 2016-179579

(51) Int. Cl. G06F 16/22; G06F 16/25; G06F 16/2457

(52) U.S. Cl. CPC G06F 16/2272; G06F 16/24578; G06F 16/2282; G06F 16/25

(57) ABSTRACT

Data of a plurality of tables are stored in compressed form so as to make integrated use of the tables easy. The ranks of entries of VL in which a value of the n-th record of the table (a1, b1) is registered are registered in the n-th entry of VL of an index of an index set (a2, b2). When integrating the index set (b2) of the table B into the integrated index (a3), a value not included in VL of the integrated index (a3) among values included in VL of the index is additionally registered (b3) in VL of the integrated index. In addition, a value indicating the ranks of entries of VL of the integrated index in which a value j registered in an entry VLE(k) of VL of the corresponding index ranked with a value k stored in the entry VNoE(i) of VNo of the index is registered is additionally registered in VNo of the integrated index.

### TECHNICAL FIELD

The present invention relates generally to a technique for integrating data of database.

### BACKGROUND ART

As a data structure of a database, a data structure of an index set as illustrated in FIG. 8A2, representing a table of a relational database (RDB) as illustrated in FIG. 8A1, is known (see, e.g., JP-A-2000-339390).

Here, the table (Table A) in FIG. 8A1 is a table with rows of records, each having a plurality of fields (“gender” and “type” in the figure). Each of the records is assigned with a record number representing the order of records in the table. The record number starts from 0.

Further, an index set (Table A index set) illustrated in FIG. 8A2 is formed with indexes provided for each field of the records of the table of FIG. 8A1. In the table of FIG. 8A1, since the fields of the records of the table are “gender” and “type,” the index of “gender” and the index of “type” are included in the index set of FIG. 8A2.

As illustrated in FIG. 8A2, each index includes VNo and VL.

VL is a list having entries in which values used as values of the corresponding fields of the corresponding table are sorted by a predetermined criterion (e.g., the ascending order of values) and registered.

For example, for the index of “gender” in the index set of the table data set of the table illustrated in FIG. 8A1, since only F and M are registered in the field of “gender” of the table, VL is a list formed with an entry in which F is registered and an entry in which M is registered.

Next, VNo is a list formed with the same number of entries as the number of records in the corresponding table. In the entry of rank n of VNo is registered a value indicating the ranking in the VL of the entry of VL in which a value of the corresponding field of the record of record number n of the corresponding table is registered. The ranking of VNo and VL starts from 0.

For example, for the index of “gender” in the index set of the table data set of the table illustrated in FIG. 8A1, a value of the field of “gender” of the record of record number 2 of the table is F and the ranking of the entry of VL in which F is registered is 0. Therefore, 1 is registered in the entry of rank 2 of VNo.

According to such an index, the number of records in the corresponding table may be obtained promptly from the number of entries of VNo, and a value of the corresponding field of a record of each record number may be promptly obtained from VNo and VL.

For example, rank 0 of VL is obtained from the entry of rank 0 of VNo corresponding to record number 2 of the index of “gender,” and since F is registered in the entry of rank 0 of VL, a value of the “gender” field of record number 2 is obtained as F.

Therefore, the table may be completely represented by the index set formed with the indexes provided for each field of such a record and may be used promptly by using the index set.

### RELATED LITERATURE

### Patent Documents

[Patent Document 1] JP-A-2000-339390

### DISCLOSURE OF THE INVENTION

### Problem that the Invention is to Solve

There are cases where multiple index sets each representing a table are stored, such as a case where a table is created for each period and is stored as a log in a storage center, or a case where a table is created, collected and stored for each region.

However, at this time, when an index set of the table is stored as it is, the following problem occurs.

As the number of stored index sets to be stored increases, the data capacity of storage required for storage also increases in proportion to the sum of data amounts of index sets to be stored.

In addition, as the number of index sets to be stored increases, it is not easy to use a plurality of tables represented by a plurality of stored index sets in an integrated manner.

For example, when three index sets, i.e., the table A index set illustrated in FIG. 8A2 which is the index set of the table A illustrated in FIG. 8A1, the table B index set illustrated in FIG. 8B2 which is the index set of the table B illustrated in FIG. 8B1 and the table C index set illustrated in FIG. 8C2 which is the index set of the table C illustrated in FIG. 8C1, are stored as they are, it is not easy to use the tables A, B, and C in an integrated manner.

For example, in order to obtain the total number of records in which the field type “gender” of the tables A, B and C is F, it is necessary to obtain the number of records whose field type “gender” in the table A is F using the table A index set, the number of records whose field type “gender” in table B is F using the table B index set, and the number of records whose field type “gender” in the table C is F using the table C index set and calculate the sum of the numbers of records obtained for the tables A, B, and C, which is a relatively complicated process whose load is high. The load of such a process sequentially increases as the number of stored index sets increases.

Meanwhile, instead of storing a plurality of index sets, when an integrated index set which is one index set representing one table integrating the tables represented by the index sets is stored, the above-described problem does not occur. In such a case, however, each time an index set to be integrated in the integrated index set is newly generated, it is necessary to perform a process of editing and rewriting the entire integrated index set according to the newly generated index set. Then, the load of this process may become excessive as the scale of the stored integrated index set increases.

An object of the present invention is to store data of a plurality of tables by a relatively simple process in a form that allows easy integrated use of the tables, while reducing the amount of data.

### Means for Solving the Problem

According to an aspect of the present invention, there is provided a method for integrating index data into integrated data, the index data representing a table in which records are arranged, each of the records is formed with one or more fields and is assigned with a record number. The index data includes an index corresponding to each of the fields. The index includes: a value list having entries, in each of which a value being used as a value of a field corresponding to the corresponding index of the record of the table represented by the index data including the index; and a correspondence value list having entries, in each of which the ranks of entries of the value list of the corresponding index in which a value of the corresponding field corresponding to the corresponding index is registered, of a record of a record number having the same value as the rank of the corresponding entry of the table represented by the index data including the corresponding index, are registered. The integrated data includes an integrated value list corresponding to each of the fields and a correspondence integrated value list corresponding to each of the fields.

The data integrating method includes: additionally registering in the correspondence integrated value list a value not registered in the integrated value list corresponding to the corresponding field among values included in the value list of the index corresponding to the corresponding field of the index data integrated in the integrated data for each field; and additionally registering an arrangement, which is obtained by arranging correspondence integrated values obtained for each entry of the correspondence value list of the index corresponding to the corresponding field of the index data integrated in the integrated data in the order according to the ranks of the correspondence value list of the corresponding entry, in the correspondence integrated value list corresponding to the corresponding field of the integrated data for each field, or adding the arrangement to the integrated data with the arrangement set as a new correspondence integrated value list corresponding to the corresponding field. The correspondence integrated value obtained for the entry of the correspondence value list has the same rank as an entry of the integrated value list corresponding to the field corresponding to the index to which the correspondence value list belongs, in which the same value as a value registered in the value list of an index to which the correspondence value list belongs, of the same rank as a rank registered in an entry of the correspondence value list.

According to another aspect of the present invention, there is provided a data integrating apparatus for performing the data integrating method.

According to the data integrating method and the data integrating apparatus, even when there are duplicates in values registered in the entries of VL of the index of the same field among the index data to be integrated in the integrated data, each value registered in each entry of the integrated value list of each integrated index of the integrated data becomes a unique value within the corresponding integrated value list. Therefore, as compared to a case where each index set is stored as it is, the data capacity of storage required for storage may be reduced.

Further, according to such data integrating method and data integrating apparatus, it is possible to integrate new index data into the integrated data by a relatively simple process that does not make any changes to the established portions of the integrated data.

In addition, since the integrated data represents a table connecting tables corresponding to each index set integrated in the integrated data, by using the integrated data, it is possible to readily operate and use the tables corresponding to the respective index data in an integrating manner.

According to another aspect of the present invention, there is provided a method for integrating a table into integrated data, the table having arranged records, each of the records is formed with one or more fields and is assigned with a record number. The integrated data includes a correspondence integrated value list corresponding to each of the fields and an integrated value list corresponding to each of the fields. The data integrating method includes: additionally registering in the integrated value list a value not registered in the integrated value list corresponding to the corresponding field among values being as values of the corresponding field of each record of the corresponding table for each field of the table integrated in the integrated data; and additionally registering an arrangement, which is obtained by arranging ranks of entries of the integrated value list corresponding to the corresponding field in the order according to the order of records in the table, in which the same value as a value of the corresponding field of each record of the corresponding table is registered, in the correspondence integrated value list corresponding to the corresponding field of the integrated data, for each field of the table integrated in the integrated data, or adding the arrangement to the integrated data with the arrangement set as a new correspondence integrated value list corresponding to the corresponding field.

According to another aspect of the present invention, there is provided a data integrating apparatus for performing the data integrating method.

According to the data integrating method and the data integrating apparatus, even if there are duplicates in values registered in the same field among the tables or records to be integrated in the integrated data, each value registered in each entry of the integrated value list of each integrated index of the integrated data becomes a unique value within the integrated value list. Therefore, as compared to a case where each table is stored as it is, the data capacity of storage required for storage may be reduced.

Further, according to such data integrating method and data integrating apparatus, it is possible to integrate new tables into the integrated data by a relatively simple process that does not make any changes to the established portions of the integrated data.

In addition, since the integrated data represents a table connecting tables integrated in the integrated data, by using the integrated data, it is possible to readily operate and use the tables in an integrating manner.

According to another aspect of the present invention, there is provided a data processing system including the above-described data integrating apparatus, and a storage storing the integrated data, including: a table operation unit that operates a table represented by the integrated data stored in the storage, assuming that the integrated data represents a table including records having values registered in entries of the integrated value list corresponding to the corresponding field of the same rank as a rank registered in an entry of the same value as the corresponding record number of the correspondence integrated value list corresponding to the corresponding field in each field of each record number.

According to another aspect of the present invention, there is provided a computer-readable and executable program that causes a computer to function as the above-described data integrating apparatus or data processing system.

As described above, according to the present invention, it is possible to store data of a plurality of tables by a relatively simple process in a form that allows easy integrated use of the tables, while reducing the amount of data.

### BRIEF DESCRIPTION OF THE DRAWINGS

FIG. 1 is a block diagram illustrating the configuration of a data processing system according to an exemplary embodiment of the present invention;

FIGS. 2A1 to 2A4 and 2B1 to 2B4 (hereinafter, “FIGS. 2A1 to 2B4”) are views illustrating the outline of a data integration process according to an exemplary embodiment of the present invention;

FIGS. 3A1, 3A2, and 3B1 to 3B4 (hereinafter, “FIGS. 3A1 to 3B4”) are views illustrating the outline of a data integration process according to an exemplary embodiment of the present invention;

FIGS. 4A to 4C are views illustrating an example of generation of an integrated index according to an exemplary embodiment of the present invention;

FIGS. 5A and 5B are views illustrating an example of generation of an integrated index according to an exemplary embodiment of the present invention;

FIG. 6 is a view illustrating an example of storage of an integrated index according to an exemplary embodiment of the present invention;

FIGS. 7A1, 7A2, 7B1, and 7B2 (hereinafter, “FIGS. 7A1 to 7B2”) are views illustrating another example of generation of the integrated index according to an exemplary embodiment of the present invention; and

FIGS. 8A1, 8A2, 8B1, 8B2, 8C1, and 8C2 (hereinafter, “8A1 to 8C2”) are views illustrating a data structure of a conventional table.

### MODE FOR CARRYING OUT THE INVENTION

Hereinafter, some exemplary embodiments of the present invention will be described.

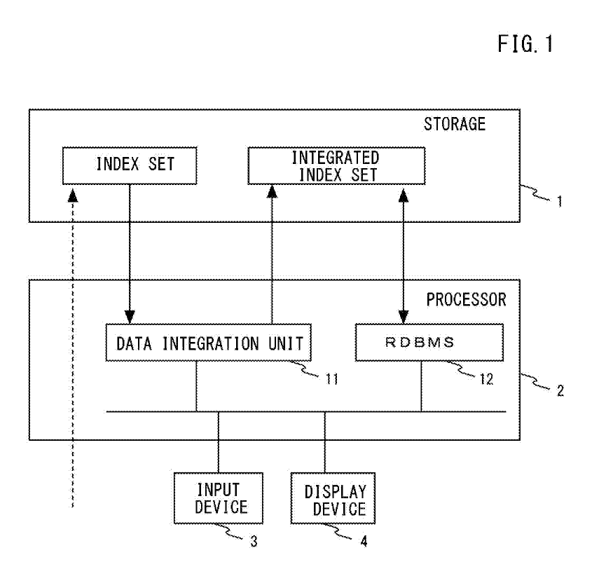

FIG. 1 illustrates the configuration of a data processing apparatus according to an exemplary embodiment.

As illustrated, the data processing apparatus includes a storage 1, a processor 2, an input device 3, a display device 4 and others. The processor 2 includes a data integration unit 11 and an RDB management system (RDBMS) 12. The data integration unit 11 and the RDBMS 12 are functional units implemented by the processor 2 executing a predetermined computer program.

With this configuration, when an index set to be newly stored is stored in the storage 1, the data integrating unit 11 of the processor 2 integrates the stored index set into an integrated index set stored in the storage 1.

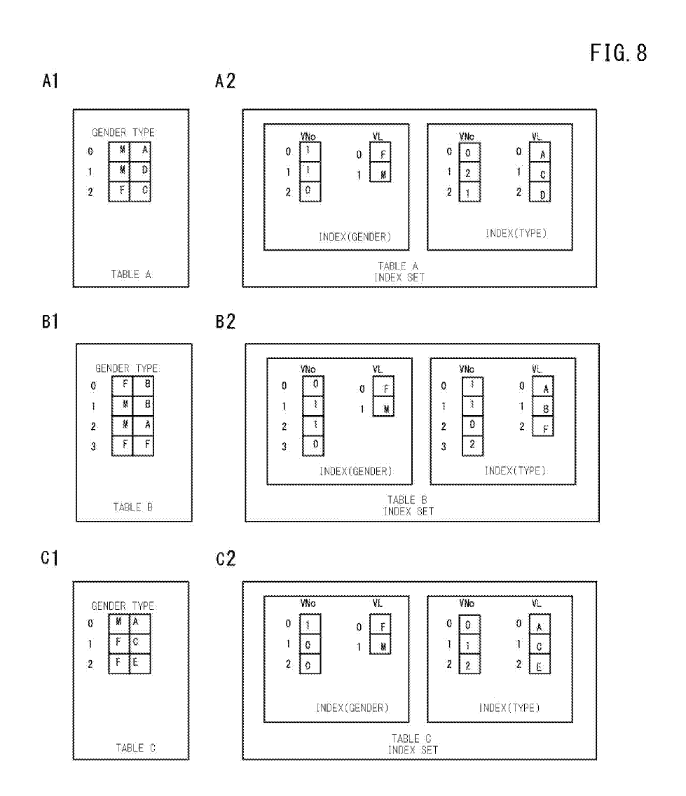

The index set to be newly stored in the storage 1 is an index set that consists of indexes including VNo and VL earlier described with reference to FIGS. 8A1 to 8C2 and represents one table in the same way as the index set of FIG. 8A2 representing the table of FIG. 8A1.

Meanwhile, the RDBMS 12 uses the integrated index set to perform an integrated operation on the tables represented by the index sets stored up to that point of time.

Next, the outline of the integrated operation of the index sets into the integrated index set performed by the data integration unit 11 will be described.

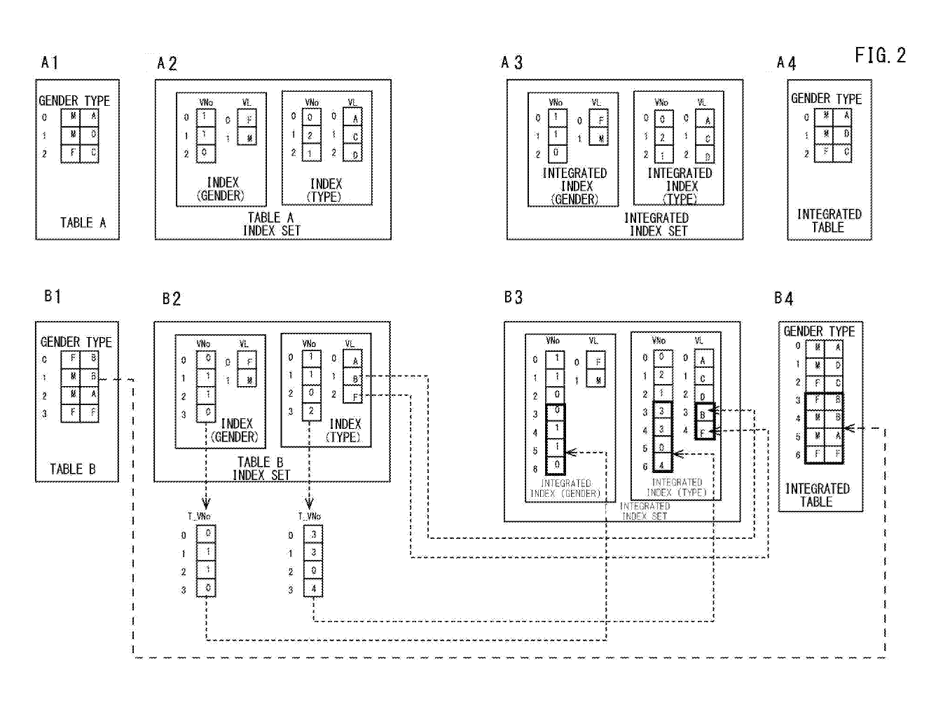

When a table A index set of FIG. 2A2 which is an index set representing the table A illustrated in FIG. 2A1 is stored as the first index set to be stored, the data integration unit 11 sets the table A index set of FIG. 2A2 to the integrated index set as it is, as illustrated in FIG. 2A3.

Therefore, as with the index set, the integrated index set has indexes for each field, each of which includes VNo and VL, and represents a table.

In the following description, an index in the index set is simply referred to as an “index” and an index in the integrated index is referred to as an “integrated index” to distinguish between them. In the following description, a table represented by the index set is simply referred to as a “table” and a table represented by the integrated index set is referred to as an “integrated table” to distinguish between them.

The integrated index set of FIG. 2A3, which was first generated as described above, represents an integrated table having the same contents as the table A as illustrated in FIG. 2A4.

Next, in a state in which the integrated index set of FIG. 2A3 is stored, when the table B index set of FIG. 2B2, which is an index set representing the table B illustrated in FIG. 2B1, is stored as the next index set to be stored, the data integration unit 11 performs the following process on each index of the table B index set.

That is, for an index corresponding to each field of the table B index set, a value not included in VL of an integrated index corresponding to the field among values included in VL of the index is additionally registered in VL of the integrated index corresponding to the field, as illustrated in FIG. 2B3.

Then, T_VNo which is a list having the same number of entries of VNo of the index is created and a value indicating the ranking of entries of VL of the integrated index of the corresponding field in which a value j registered in an entry VLE(k) of VL of the corresponding index ranked with a value k stored in an entry VNoE(i) of VNo of the corresponding index is registered and having the same ranking as the entry T_VNoE(i) of the corresponding T_VNo is registered in each entry of T_VNo. Then, each entry of T_VNo is additionally registered in VNo of the integrated index of the corresponding field, as illustrated in FIG. 2B3.

T_VNoE(i) represents the i^{th} entry of T_VNo, VNoE(i) represents the i^{th} entry of VNo, and VLE(k) represents the k^{th} entry of VL.

More specifically, for example, in a case of the index of the field “type,” since the number of entries of VNo of the index is 4, T_VNo having four entries is created.

For example, 3 is registered in an entry of rank 0 of T_VNo since a value registered in an entry of rank 0 of VNo of the corresponding index is 1 and a value registered in an entry of rank 1 of VL of the corresponding index is B which is registered in an entry of rank 3 of VL of the integrated index of the field “type.”

Similarly, for example, 0 is registered in an entry of rank 2 of T_VNo since a value registered in an entry of rank 2 of VNo of the corresponding index is 0 and a value registered in an entry of rank 0 of VL of the corresponding index is A which is registered in an entry of rank 0 of VL of the integrated index of the field “type.”

Similarly, when a value is registered in each entry of T_VNo, each entry of T_VNo is added to VNo of the integrated index of the field “type.”

The integrated table represented by the integrated index set illustrated in FIG. 2B3 created as described above is obtained by linking the table A and the table B in this order, as illustrated in FIG. 2B4.

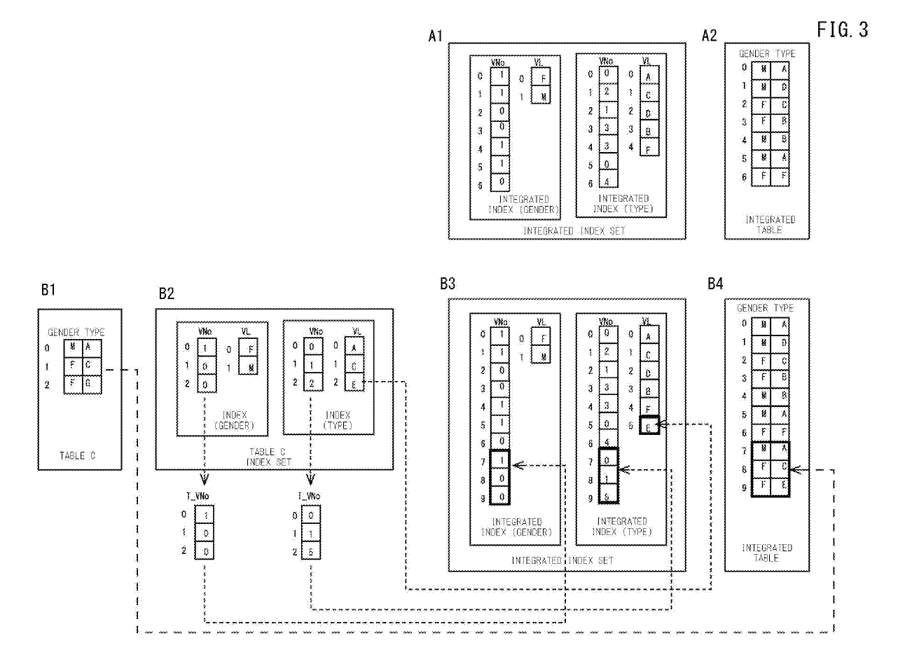

Next, in the way described above, the table B index set is integrated in the integrated index set and, in a state where the integrated index set of FIG. 3A1 representing the integrated table illustrated in FIG. 3A2 is stored, when the table C index set of FIG. 3B2 which is the index set representing the table C illustrated in FIG. 3B1 is stored as an index set to be stored next, the data integration unit 11 performs the following process on each index of the table C index set in the same way as described above.

Specifically, for an index corresponding to each field of the table C index set, a value not included in VL of the integrated index of the corresponding field among values included in VL of the index is additionally registered in VL of the integrated index of the corresponding field, as illustrated in FIG. 3B3.

Then, T_VNo which is a list having the same number of entries of VNo of the index is created and a value indicating the ranking of entries of VL of the integrated index of the corresponding field in which a value j registered in an entry VLE(k) of VL of the corresponding index ranked with a value k stored in an entry VNoE(i) of VNo of the corresponding index is registered and having the same ranking as the entry T_VNoE(i) of the corresponding T_VNo is registered in each entry of T_VNo. Then, each entry of T_VNo is additionally registered in VNo of the integrated index of the corresponding field, as illustrated in FIG. 3B3.

As a result, the integrated table represented by the integrated index set illustrated in FIG. 3B3 created as described above is obtained by linking the table A, the table B and the table C in this order, as illustrated in FIG. 3B4.

Hereinafter, every time an index set to be stored next occurs, the same process is performed to integrate the index set in the integrated index set.

Data indicating which range of an entry of VNo of the integrated index is created from an index indicating which index or which table may be included in the integrated index set, as corresponding data. This makes it easy to diversely use the integrated index set on a table or index basis.

As described above, in the present exemplary embodiment, when integrating a new index set in the integrated index set, by additionally registering the contents corresponding to the contents of the new index set in the integrated index set with no change in the already registered portion of the integrated index set, integration of the index set in the integrated index set is implemented.

Even when there are duplicates in values registered in the entries of VL of the index of the same field among the index sets to be integrated in the integrated index set, each value registered in each entry of VL of each integrated index of the integrated index set becomes a unique value within VL of the integrated index. Therefore, as compared to a case where each index set is stored as it is, the data capacity of the storage 1 required for storage may be reduced.

Next, the detailed procedure for integrating the index set in the integrated index set as described above will be described.

As described above, the integration of the index set in the integrated index set is implemented by editing the integrated index for each index of each field according to the contents of the index.

The edition of the integrated index according to the contents of the index may be implemented by the following procedure, for example.

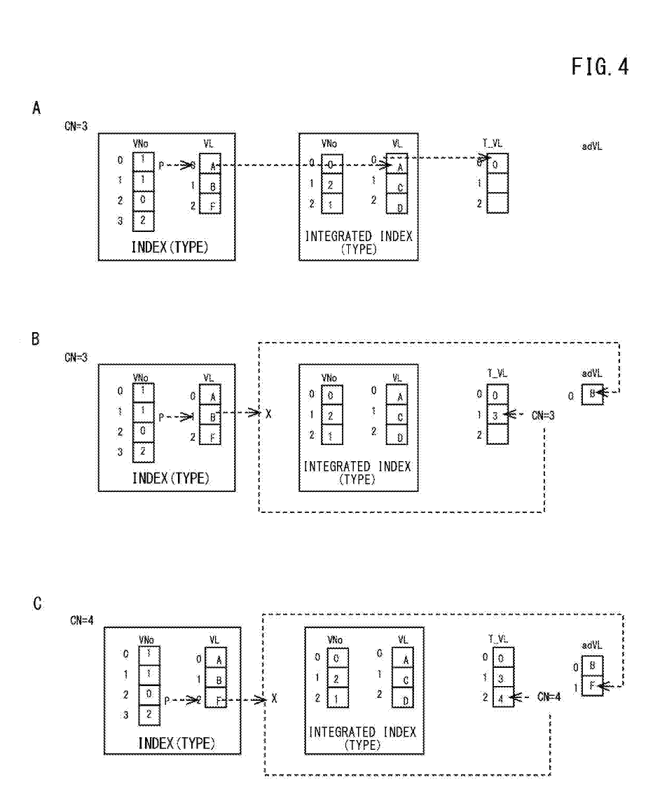

Here, explanation will be given, taking as an example, a case of editing an integrated index illustrated in FIG. 4A according to the contents of an index illustrated in the figure.

In this case, first, a registered value checking process is performed.

In this registered value checking process, first, a pointer P is set to 0 and a current number CN is set to 3 which is the next ranking of the entry at the end of VL of the integrated index. Then, T_VL having the same number of entries as VL of the index and an additional value list adVL are created.

Then, a value A registered in an entry of rank 0 indicated by the pointer P of VL of the index is acquired and it is checked whether or not the acquired value A is stored in VL of the integrated index. Here, since the value A is stored in VL of the integrated index, the rank 0 of the entry of VL of the integrated index in which the value A is stored is acquired and registered in the entry of rank 0 indicated by the pointer P of T_VL.

Then, it is checked whether or not the value of the pointer P matches the ranking of the entry at the end of VL of the index. Here, since there is no match, the value of the pointer P is incremented by one and is set to 1.

Next, after the value of the pointer P is incremented by one, a value B registered in an entry of rank 1 indicated by the pointer P of VL of the index is acquired as illustrated in FIG. 4B and it is checked whether or not the acquired value B is stored in VL of the integrated index. Here, since the value B is not stored in VL of the integrated index, the acquired value B is additionally registered in the additional value list adVL. Further, the value 3 of the current number CN is registered in the entry of rank 1 indicated by the pointer P of T_VL and the value of the current number CN is incremented by one and is set to 4. The value of the current number CN is incremented by one when the value of the current number CN is registered in an entry of T_VL.

Then, it is checked whether or not the value of the pointer P matches the ranking of the entry at the end of VL of the index. Here, since there is no match, the value of the pointer P is incremented by one and is set to 2.

Next, after the value of the pointer P is incremented by one, a value F registered in an entry of rank 2 indicated by the pointer P of VL of the index is acquired as illustrated in FIG. 4C and it is checked whether or not the acquired value F is stored in VL of the integrated index. Here, since the value F is not stored in VL of the integrated index, the acquired value F is additionally registered in the additional value list adVL. Further, the value 4 of the current number CN is registered in the entry of rank 2 indicated by the pointer P of T_VL.

Then, it is checked whether or not the value of the pointer P matches the entry at the end of VL of the index. Here, since there is a match, the registered value checking process is ended.

Then, when the registration value checking process is completed, a T_VNo creation process is performed.

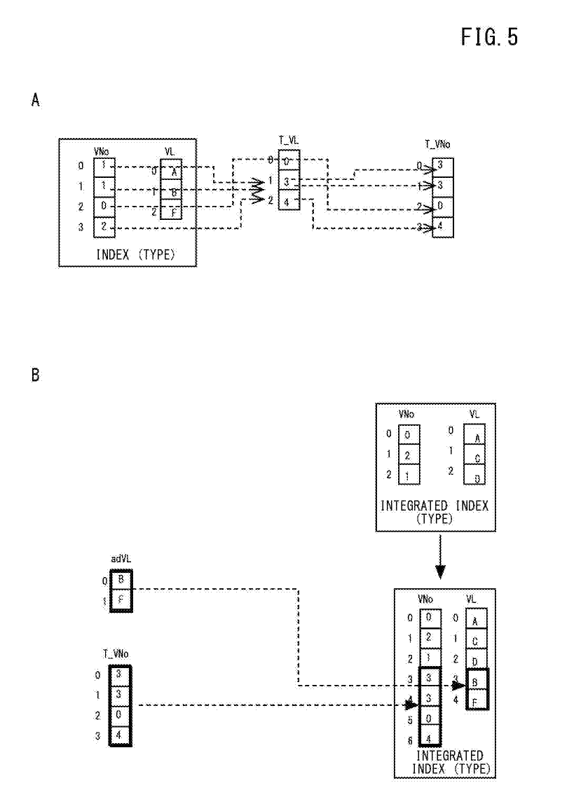

In the T_VNo creation process, as illustrated in FIG. 5A, T_VNo having the same number of entries as VNo of the index is created.

For each entry of the index VNo, a value X stored in an entry of the corresponding rank i is acquired. Then, a value Y registered in an entry of T_VL of the same rank X as the acquired value X is registered in the entry of T_VNo of rank i. For example, as for an entry of rank 1 of VNo of the index, since a value registered in an entry of rank 1 of VNo of the index is 1, the value 3 registered in the entry of T_VL of rank 1 is acquired. Then, the acquired value 3 is registered in the entry of rank 1 of T_VNo.

Then, after registering a value in each entry of T_VNo in this way, the T_VNo creation process is ended.

Then, as illustrated in FIG. 5B, each entry of the additional value list adVL created by the registered value checking process is added to VL of the integrated index and each entry of T_VNo created by the T_VNo creation process is added to VNo of the integrated index.

The operation of integration of the index set in the integrated index set performed by the data integration unit 11 has been described above.

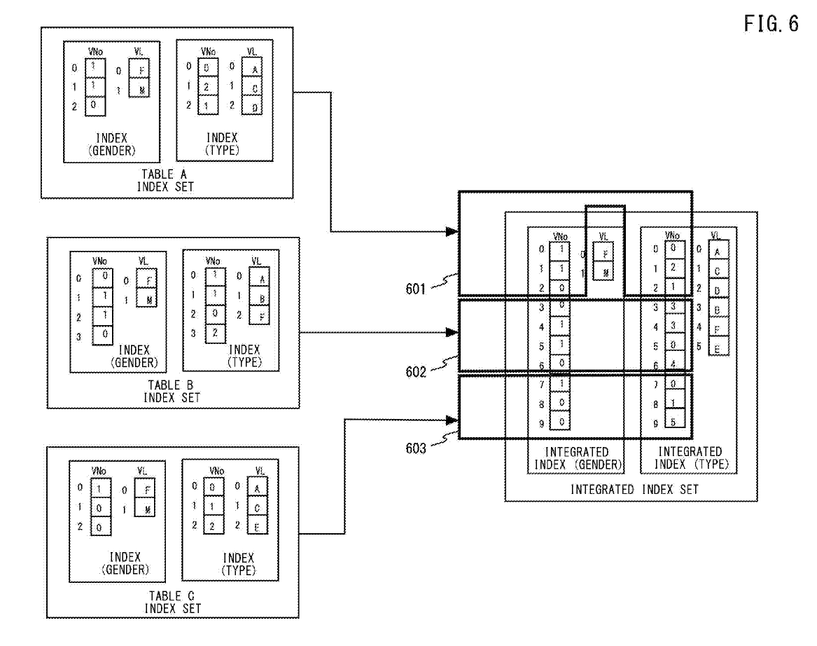

In the meantime, as illustrated in FIG. 6, the integrated index set created in this manner may be created and stored as a separate data structure for each portion of VNo of each integrated index of the integrated index set created from different index sets. For example, a portion 601 of VNo of each integrated index of the integrated index set first created from the table A index set, a portion 602 of VNo of each integrated index created when integrating the table B index set in the integrated index set and added to the integrated index set, and a portion 603 of VNo of each integrated index created when integrating the table C index set in the integrated index set and added to the integrated index set may be stored in the storage 1 as a separate data structure such as separate files or separate file groups. In addition, in this case, an index that was the creator of each data structure, or a table represented by the index that was the creator of each data structure, and data indicating the correspondence of the data structure, may be included as corresponding data in the integrated index set. This makes it easy to diversely use the integrated index set on a table or index basis.

Even in this case, since the concatenation of portions corresponding to the respective fields of the VNo portions 601, 602 and 603 forms VNo of the integrated index corresponding to the corresponding field, there is no change in logical representation of the integrated index table.

Hereinafter, an integrated operation for each table represented by the index set stored up to that time using the integrated index set, which is performed by the RDBMS 12 of the processor 2, will be described.

Assuming that the integrated index set illustrated in FIG. 3B3 is stored in the storage 1, the RDBMS 12 performs the following process when an operation for obtaining a record having a specific value in a specific field is performed.

Specifically, first, the rank of entries of VL of the integrated index of the specific field of the integrated index set in which the specific value is registered is obtained. Then, the rank of each entry of VNo of the integrated index in which the obtained rank is registered is obtained. Then, a record having the obtained rank as a record number is extracted as a record number of a record to be obtained.

Next, for each extracted record number, the following process is performed to obtain a value of each field of the record of the record number.

Specifically, for the integrated index of each field of the integrated index, a value registered in an entry having the same rank as the corresponding record number of VNo of the integrated index is obtained and a value registered in VL of the integrated index of the same rank as the obtained value is calculated as a value of the field corresponding to the integrated index of the record of the corresponding record number.

In addition, when performing an operation of obtaining a record having a value within a specific range in a specific field, the RDBMS 12 performs a process of setting each value within the specific range as a specific value and obtaining a record having a specific value in the specific field.

Further, the RDBMS 12 performs the following process when an operation of obtaining the number of records having a specific value in a specific field is performed.

In this case, the rank of entries in which the specific value of VL of the integrated index of the specific field of the integrated index set is registered is obtained. Then, the number of entries of VNo of the corresponding integrated index in which the obtained rank is registered is calculated as the number of records having a specific value in the specific field.

In addition, the RDBMS 12 performs the following process when an operation of sorting records of an integrated table represented by the integrated index set by a value of a specific field is performed.

Specifically, the ranks of entries of VL of the integrated index of the corresponding specific field of the integrated index set are arranged according to the order of values registered in the corresponding entry (for example, in the descending order of values). Then, the ranks of entries of VNo in which the corresponding value is registered are obtained in the order of arrangement of the arranged values, and the obtained ranks of entries of VNo are arranged according to the order in which the ranks are obtained. Then, the arrangement of the ranks obtained thus is calculated as an arrangement of sorted record numbers. Then, the value of each field of each record of each record number is obtained as described above and is arranged in the order of the sorted record number to create a sorted table.

The above-described operation may be performed only on a range of VNo corresponding to a specific table/index when the above-described corresponding data is included in the integrated index set.

As described above, according to the integrated index set according to the present exemplary embodiment, the RDBMS 12 may promptly perform the integrated operation on each table represented by each index set integrated in the integrated index set through the direct operation on the integrated index set.

The exemplary embodiment of the present invention has been described above.

In the above exemplary embodiment, when index sets having different field configurations are stored in the storage 1, by adding an index with a blank value or rearranging the order of indexes, the stored index sets may be converted into index sets having a common field configuration and then integrated into the integrated index set.

In addition, in the above exemplary embodiment, when an index set to be newly stored is stored in the storage 1, the data integration unit 11 of the processor 2 integrates the stored index set in the integrated index set stored in the storage 1. In this exemplary embodiment, when a table to be newly stored is stored in the storage 1, the data integration unit 11 of the processor 2 may first create an index set from the stored table, as described with reference to FIGS. 8A1 to 8C2, and then integrate the created index set in the integrated index set stored in the storage 1.

In this case, when tables having different field configurations are stored in the storage 1, by adding a blank field to the tables or rearranging the order of fields of the tables, an index set may be created after the stored tables are converted into a table having a common field configuration.

In addition, when creating an integrated index set from a table in this manner, the data integration unit 11 of the processor 2 may create the integrated table as follows.

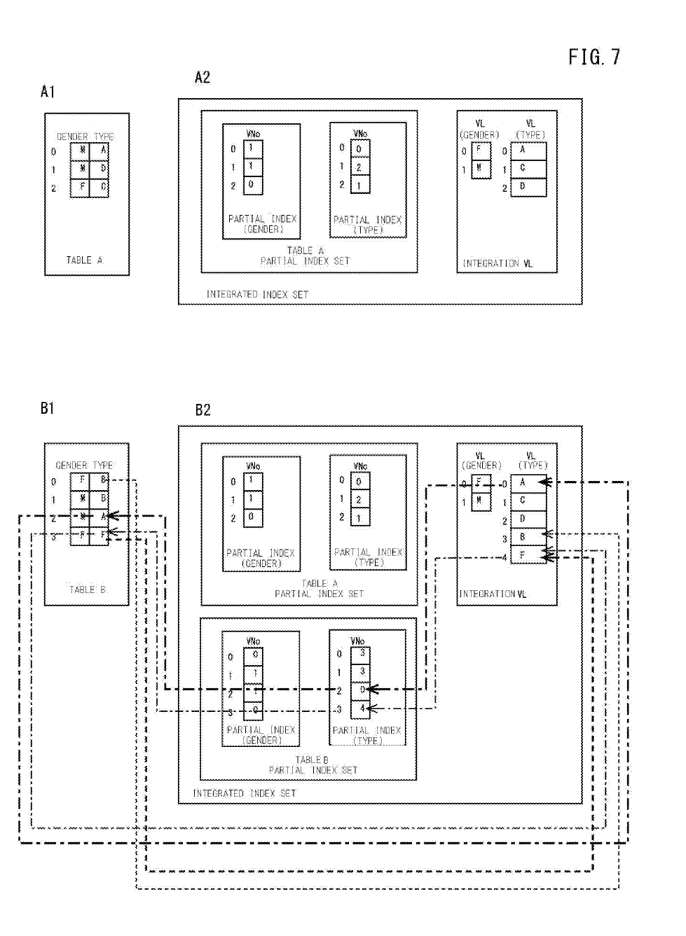

Specifically, as illustrated in FIG. 7A1, when the first table A to be integrated in the integrated index set is stored in the storage 1, VNO and VL for each field (the field “gender” and the field “type”) are first created as described with reference to FIGS. 8A1 to 8C2, and then, as illustrated in FIG. 7A2, VNo created for each field is set as a partial index of the corresponding field and a table A partial index set including the partial index created for each field is stored in the integrated index set. In addition, the integrated VL including VL created for each field is stored in the integrated index set.

Then, in a state where the integrated index set illustrated in FIG. 7A2 is stored in the storage 1, when the table B illustrated in FIG. 7B1 is stored in the storage 1, as to the field of the table B, a value not registered in VL of the corresponding field of the integrated VL of the integrated index set among values (unique value) being used in the corresponding field of each record is additionally registered in VL of the corresponding field of the integrated VL, as illustrated in FIG. 7B2.

For example, for the field “type,” since B and F of the values of the field “type” of each record in the table B are not registered in VL of the field “type” of the integrated VL of the integrated index set illustrated in FIG. 7A2, B and F are added to VL of the field “type” of the integrated VL, as illustrated in FIG. 7B2.

Next, for each field in the table B, VNo is created as follows.

Specifically, for each field of the table B, VNo formed with the same number of entries as the number of records in the table B is created, and a value indicating the ranks of entries in VL of the corresponding field of the integrated VL of the integrated index set in which a value of the corresponding field of a record of a record number n of the corresponding table is registered is registered in an entry of the rank n of VNo.

For example, for the field “type”, since the number of records in the table B is 4, VNo of the field “type” having four entries is created, and a value indicating the ranks of entries in VL of the field “type” of the integrated VL (VL (type)) in which a value of the field “type” of a record of a record number i of the table B is registered is registered in an entry of the rank i of the created VNo of the field “type.” For example, since a value of the field “type” of a record of a record number 2 of the table B is A which is registered in an entry of the rank 0 of VL of the field “type” of the integrated VL (VL (type)), 0 is registered in an entry of the rank 2 of VNo of the field “type.” In addition, since a value of the field “type” of a record of a record number 3 of the table B is F which is registered in an entry of the rank 4 of VL of the field “type” of the integrated VL (VL (type)), 4 is registered in an entry of the rank 3 of VNo of the field “type.”

As described above, the VNo created for each field is set as a partial index of the corresponding field, and a table B partial index set including the partial index created for each field is stored in the integrated index set.

Thereafter, each time the table B is stored in the storage 1, the same process as in the case of table B is performed to integrate the stored table in the integrated index set.

In this case, data indicating which table each partial index set was created from may be included as the above-described corresponding data in the integrated index set. This makes it easy to diversely use the integrated index set on a table basis.

VNos of the partial index of each field of each index set of each table of the integrated index set in FIG. 7B1 may be concatenated and stored as an integrated partial index in the integrated set. In this case, data indicating which range of the entry of VNo of the integrated partial index is created from which table may be included as the above-described corresponding data in the integrated index set. This makes it easy to diversely use the integrated index set on a table basis.

Here, VNo of each field when VNos of the partial index are concatenated and stored as an integrated partial index in this manner is equal to VNo of an index of each field of the integrated index set illustrated in FIG. 2B3 which is obtained by integrating index sets of two tables (the table A in FIG. 2A1 and the table B in FIG. 2B2), which are respectively equal to the table A in FIG. 7A1 and the table B in FIG. 7B1, as illustrated in FIGS. 2A1 to 2B4. VL of each field of the integrated VL is also equal to VL of each field of the integrated index set illustrated in FIG. 2B3.

That is, the data structure of the integrated index set when VNos of the partial index are concatenated and stored as the integrated partial index has the same configuration as the data structure of the integrated index set illustrated in FIG. 2B3.

On the contrary, the data structure of the integrated index set illustrated in FIG. 2B3 when VNos of each integrated index of the integrated index set created from the different index sets as described above are created and stored as separate data structures as illustrated in FIG. 6 has the same configuration as the data structure of the integrated index set illustrated in FIG. 7B2.

Therefore, according to the process of integrating the table illustrated in FIGS. 7A1 to 7B2 in the integrated index set, it is possible to integrate the table in the integrated index set without going through an index set. In addition, it may be used in the same way as the integrated index set created by integrating index sets as described above.

Further, in the process of integrating the table illustrated in FIGS. 7A1 to 7B2 in the integrated index set, when integrating a new table in the integrated index set, contents according to the contents of the new table are additionally registered in the integrated index set with no change in the already registered portion of the integrated index set, thereby implementing integration of the table in the integrated index set.

Even in the case illustrated in FIGS. 7A1 to 7B2, when tables having different field configurations are stored in the storage 1, by adding a blank field to the tables or rearranging the order of fields of the tables, the stored tables may be processed after being converted into a table having a common field configuration.

### DESCRIPTION OF REFERENCE NUMERALS AND SIGNS

1 . . . storage, 2 . . . processor, 3 . . . input device, 4 . . . display device, 11 . . . integration unit, 12 . . . RDBMS

What is claimed is:

1. A method for integrating index data into integrated data, the index data representing a table in which records are arranged, each of the records being formed with one or more fields and is assigned with a record number,
wherein the index data includes an index corresponding to each of the fields,
the index includes:
a value list having entries, in each of which a value being used as a value of a field corresponding to the corresponding index of the record of the table represented by the index data including the index; and
a correspondence value list having entries, in each of which the ranks of entries of the value list of the corresponding index in which a value of the corresponding field corresponding to the corresponding index is registered, of a record of a record number having the same value as the rank of the corresponding entry of the table represented by the index data including the corresponding index, are registered, and
the integrated data includes an integrated value list corresponding to each of the fields and a correspondence integrated value list corresponding to each of the fields,
the method comprising:
additionally registering in the correspondence integrated value list a value not registered in the integrated value list corresponding to the corresponding field among values included in the value list of the index corresponding to the corresponding field of the index data integrated in the integrated data for each field; and
additionally registering an arrangement, which is obtained by arranging correspondence integrated values obtained for each entry of the correspondence value list of the index corresponding to the corresponding field of the index data integrated in the integrated data in the order according to the ranks of the correspondence value list of the corresponding entry, in the correspondence integrated value list corresponding to the corresponding field of the integrated data for each field, or adding the arrangement to the integrated data with the arrangement set as a new correspondence integrated value list corresponding to the corresponding field,
wherein the correspondence integrated value obtained for the entry of the correspondence value list has the same rank as an entry of the integrated value list corresponding to the field corresponding to the index to which the correspondence value list belongs, in which the same value as a value registered in the value list of an index to which the correspondence value list belongs, of the same rank as a rank registered in an entry of the correspondence value list.

2. A method for integrating a table into integrated data, the table having arranged records, each of the records being formed with one or more fields and is assigned with a record number,
wherein the integrated data includes a correspondence integrated value list corresponding to each of the fields and an integrated value list corresponding to each of the fields,
the method comprising:
additionally registering in the integrated value list a value not registered in the integrated value list corresponding to the corresponding field among values being as values of the corresponding field of each record of the corresponding table for each field of the table integrated in the integrated data; and
additionally registering an arrangement, which is obtained by arranging ranks of entries of the integrated value list corresponding to the corresponding field in the order according to the order of records in the table, in which the same value as a value of the corresponding field of each record of the corresponding table is registered, in the correspondence integrated value list corresponding to the corresponding field of the integrated data, for each field of the table integrated in the integrated data, or adding the arrangement to the integrated data with the arrangement set as a new correspondence integrated value list corresponding to the corresponding field.

3. (canceled)

4. An apparatus for integrating a table into integrated data, the table having arranged records, each of the records being formed with one or more fields and is assigned with a record number,
wherein the integrated data includes a correspondence integrated value list corresponding to each of the fields and an integrated value list corresponding to each of the fields,
the apparatus comprising:
a value integrating unit that additionally registers in the integrated value list a value not registered in the integrated value list corresponding to the corresponding field among values being as values of the corresponding field of each record of the corresponding table for each field of the table integrated in the integrated data; and
a correspondence value registering unit that additionally registers an arrangement, which is obtained by arranging ranks of entries of the integrated value list corresponding to the corresponding field in the order according to the order of records in the table, in which the same value as a value of the corresponding field of each record of the corresponding table is registered, in the correspondence integrated value list corresponding to the corresponding field of the integrated data, for each field of the table integrated in the integrated data, or adds the arrangement to the integrated data with the arrangement set as a new correspondence integrated value list corresponding to the corresponding field.

5. A data processing system including a data integrating apparatus according to claim 4, and a storage storing the integrated data, the data processing system comprising:
a table operation unit that operates a table represented by the integrated data stored in the storage, assuming that the integrated data represents a table including records having values registered in entries of the integrated value list corresponding to the corresponding field of the same rank as a rank registered in an entry of the same value as the corresponding record number of the correspondence integrated value list corresponding to the corresponding field in each field of each record number.

6. (canceled)

7. (canceled)
